(19) United States
(12) Patent Application Publication
(10) Pub. No.: US 2005/0138157 A1
(43) Pub. Date: Jun. 23, 2005

(54) Network device discovery system and method thereof

(76) Inventors: Ken-Ju Jung, Hsinchu City (TW); Mao-I Wu, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/743,931

(22) Filed: Dec. 23, 2003

(51) Int. Cl. G06F 15/173

(52) U.S. Cl. 709/223

(57) ABSTRACT

A system and method for automated network device discovery including a discovery module. The discovery module issues a series of relayed single-destination simple network management protocol (SNMP) requests to network devices to acquire Cisco discovery protocol (CDP) neighbor device data, generates network device inventory records corresponding to the CDP neighbor devices, and stores the network device inventory records to a storage device.

### BACKGROUND

The present invention relates to network device management technology, and more particularly, to a method and system of automated network device discovery and management.

A network is a communication system that links two or more computers and peripheral devices, and allows users to access resources on other computers and exchange messages with other users. A network allows users to share resources on their own systems with other network users and to access information on centrally located systems or systems that are located at remote offices. A local area network (“LAN”) is a network that is located in a relatively small physical area, such as a building, in which computers and other network devices are linked, usually via a wire-based cabling scheme. Data is typically packaged into frames for transmission on the LAN.

A LAN typically includes numerous significant network devices, such as switches, routers, access points and the like, to transmit information from a source device to one or more destination devices. Switching is a technology that alleviates congestion in Ethernet, Token Ring, and Fiber Distributed Data Interface (FDDI) and other similar LANs by reducing traffic and increasing bandwidth. A LAN switch behaves similarly to a bridge, which is a kind of network device, connecting two or more LAN segments. A switch transmits frames of data from one segment to their destinations on the same or other segments. A router is an internetworking device, typically used to connect similar and heterogeneous network segments to the Internet. For example, two LANs may be connected across a dial-up line, across the Integrated Services Digital Network (ISDN), or across a leased line via routers. Routers may also be found throughout the Internet. Users may connect to a local Internet Service Provider (ISP).

As a LAN grows, network devices are typically added to the LAN and interconnected according to the needs of the particular LAN to which they belong. Network devices need to be configured and managed by a number of programmable features that can be changed by an operator for optimal performance in a particular network. Therefore, it is necessary to acquire relevant information from network devices to facilitate network configuration and management. Since a firm may own numerous LANs located in different buildings or countries, the network topology and network devices attached to the network can be difficult to acquire manually.

The HP OpenView and CiscoWork system have been used in various network management processes for automated network device discovery. The HP OpenView system discovers network devices using the industry standard address resolution protocol over the simple network management protocol (ARP/SNMP) to acquire a media access control (MAC) address for a given internet protocol (IP) address. The system sends a SNMP request to acquire an ARP table cached in a network device, containing neighboring IP addresses, and accordingly acquire other ARP tables. Although the ARP/SNMP technique is feasible, several limitations remain. An ARP table contains IP addresses of not only network devices but numerous PCs and peripheral devices. The HP OpenView system is time intensive, particularly when waiting for a time-out message corresponding to a PC or a peripheral device not contained in any ARP table.

To address the above limitation, the CiscoWork system employs the Cisco discovery protocol (CDP) to automatically discover network devices. CDP is a media-independent device discovery protocol which can be used by an operator to view information about other network devices directly attached to a particular network device. Although the discovery performance is better than that of the HP OpenView system, it takes an unnecessarily long time to recursively discover network devices according to the predetermined complicated hierarchical structure.

In view of these limitations, a need exists for a system and method of automated network device discovery that reduces discovery time.

### SUMMARY

It is therefore an object of the present invention to provide a system and method of automated network device discovery to reduce discovery time.

According to an illustrative embodiment of the invention, the system includes an automated network device discovery apparatus and four network devices including two routers, a switch and an access point. Network devices can be configured and managed by connecting to the console port from a terminal or remotely through a modem, connecting via Telnet using a management console, or communicating with the management interface using the industry standard, simple network management protocol (SNMP) and the management interface base (MIB) files. The MIB is the repository employing a tree structure to store information about device parameters and network data. The MIB variables of network devices according the embodiment of the invention are accessible through SNMP. The network devices support Cisco discovery protocol (CDP), thus the MIB therein stores multiple CDP neighbor data including a MAC address, an IP address, a device type or others. Each network device includes an SNMP agent to return device parameters, network data, CDP neighbor data, or other MIB variables when receiving an SNMP get-request.

The automated network device discovery apparatus includes a central processing unit (CPU), a memory, a storage device, an input device, a display device and a communication device. The CPU is connected by buses to the memory, storage device, input device, display device and communication device based on Von Neumann architecture. The CPU is controlled by instructions received from the memory and from an operator through the input device, and executes automated network device discovery functions.

The storage device stores multiple network device inventory records. The network device inventory record is capable of storing configuration and specification information of a network device, preferably including a device type, a media access control (MAC) address, an internet protocol (IP) address, neighbor network devices, interfaces, a firmware version, a RAM size and an OS version.

The memory preferably includes a discovery module and a display module, which include routines for performing automated network device discovery functions.

The discovery module selects a network device as a candidate device, generates a new network device inventory record including the candidate device data, issues an SNMP request with the IP address of the candidate device to acquire CDP neighbor device data, and stores the CDP neighbor device identities into a temporary queue. The discovery module repeatedly pops a device identity as a candidate device out of the queue on first-in-first-out (FIFO) basis, generates a new network device inventory record including the candidate device data, issues an SNMP request with the candidate IP address to acquire CDP neighbor device data, puts the newly discovered neighbor device identity into the queue until the inventory queue is empty.

The display module provides a graphical user interface (GUI) to display the network device inventory records. The GUI provides a tree view employed to facilitate an operator to select and browse specific records.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a diagram of the architecture of an illustrative embodiment of the system for automated network device discovery according to the present invention;

FIG. 2 is a diagram of the architecture of an automated network device discovery apparatus according to the present invention;

FIG. 3 is a flowchart showing the method of automated network device discovery according to the present invention;

FIG. 4 is a diagram of a storage medium for storing a computer program providing the method of automated network device discovery according to the invention.

### DESCRIPTION

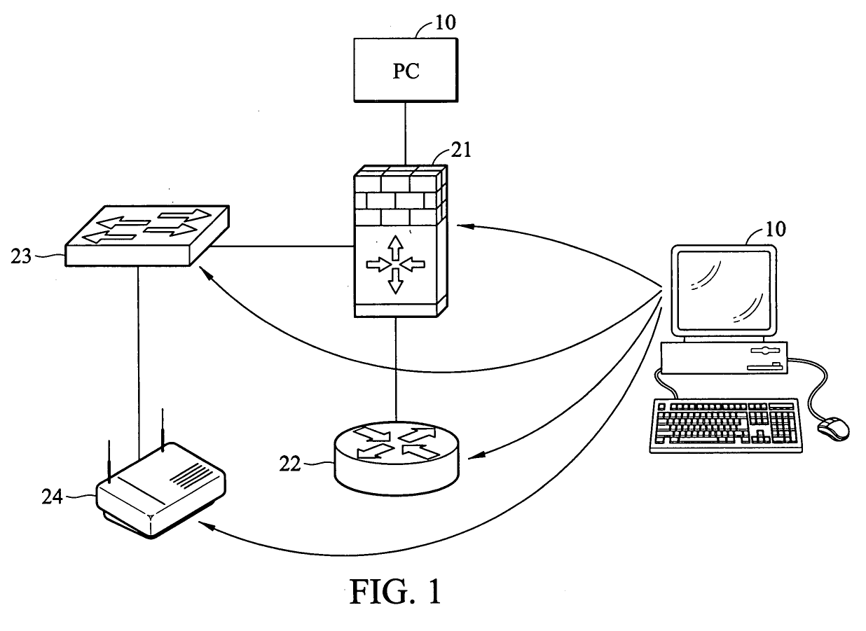

FIG. 1 is a diagram of the architecture of the system for automated network device discovery according to the present invention. According to an embodiment of the invention, the system includes an automated network device discovery apparatus 10 and four network devices including routers 21 and 22, a switch 23 and an access point 24. The router 21 has two neighbors, the router 22 and the switch 23, and the switch 23 has two neighbors, the access point 24, and the router 21. Network devices are able to be configured and managed by connecting to the console port from a terminal or remotely through a modem, connecting via Telnet using a management console, or communicating with the management interface using the industry standard, simple network management protocol (SNMP) and the management interface base (MIB) files. The MIB is the repository employing a tree structure to store information about device parameters and network data. The MIB variables of network devices according to the embodiment of the invention are accessible through SNMP. SNMP is an application layer protocol designed to facilitate the exchange of management information between network devices. SNMP consists of three parts: a structure of management information (SMI), a management information base (MIB) and the protocol itself. The SMI and MIB define and store the set of managed entities, while SNMP itself conveys information to and from the SMI and MIB. The network devices 21, 22, 23 and 24, support Cisco discovery protocol (CDP), thus the MIB therein stores multiple CDP neighbor data including a MAC address, an IP address, a device type or others. It is noted only network devices other than PCs, printers, or other peripherals, can be a CDP neighbor. Each network device includes an SNMP agent to return a device parameter, network data, CDP neighbor data, or other MIB variables when receiving an SNMP get-request.

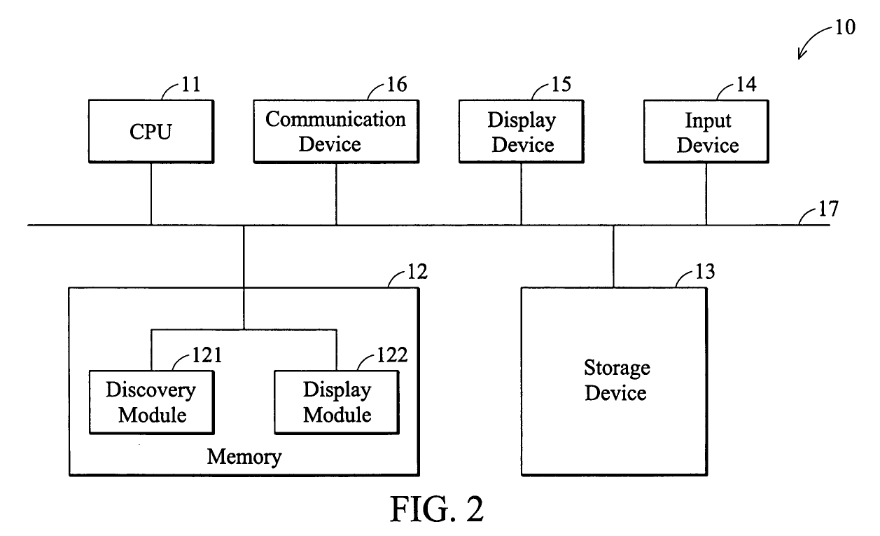

FIG. 2 is a diagram of the architecture of an automated network device discovery apparatus according to the present invention. The automated network device discovery and management apparatus 10 includes a central processing unit (CPU) 11, a memory 12, a storage device 13, an input device 14, a display device 15 and a communication device 16. The CPU 11 is connected by buses 17 to the memory 12, storage device 13, input device 14, display device 15 and communication device 16 based on Von Neumann architecture. The CPU 11, memory 12, storage device 13, display device 14, input device 15 and communication device 16 may be conventionally coupled to a mainframe computer, a mini-computer, a workstation computer, a personal computer, or a mobile computer.

The CPU 11 is controlled by instructions received from the memory 12 and from an operator through the input device 14, to execute automated network device discovery functions.

The storage device 13 can be implemented as a database system, a file, or the like, to store multiple network device inventory records. The network device inventory record is capable of storing configuration and specification information of a network device, preferably including a device type, a media access control (MAC) address, an internet protocol (IP) address, neighbor network devices, interfaces, a firmware version, a RAM size and an OS version. Consistent with the scope and spirit of the invention, additional or different fields may be provided. The MAC address is the unique hexadecimal serial number assigned to each Ethernet network device to identify it on the network. With Ethernet devices, this address is permanently set at the time of manufacture. Each network device has a unique MAC address, so that it is capable of receiving only the frames sent to it.

The memory 12 is preferably a random access memory (RAM), but may also include read-only memory (ROM) or flash ROM. The memory 12 preferably includes a discovery module 121 and a display module 122, which include routines to perform automated network device discovery functions.

The discovery module 121 selects a network device as a candidate device, generates a new network device inventory record including the candidate device data, issues an SNMP request with the IP address of the candidate device to acquire the CDP neighbor device data, and store the CDP neighbor device identities into a temporary queue. The discovery module 121 repeatedly pops a device identity as a candidate device out of the queue on first-in-first-out (FIFO) basis, generates a new network device inventory record including the candidate device data, issues an SNMP request with the candidate IP address to acquire CDP neighbor device data, stores the newly discovered neighbor device identity in the queue until the inventory queue is empty. Those skilled in the art understand the SNMP request is utilized to acquire not only the CDP neighbor device data but device parameters itself.

According to an illustrative embodiment of the invention, referring to FIG. 1, the discovery module 121 selects the router 21 as a start device, generates a new network device inventory record including the router 21, issues an SNMP request with the IP address of the router 21 to acquire the CDP neighbor device identities, such as the router 22 and switch 23, and stores the CDP neighbor device identities in a temporary queue. The discovery module 121 pops the router 22 identity out of the queue, generates a new network device inventory record containing the router 22 data, acquires the CDP neighbor device identity, such as the router 21, by issuing an SNMP request with the IP address of the router 22 and stores nothing into the queue because the router 21 data is recorded in the storage device 13. Next, the discovery module 121 pops the switch 23 identity out of the queue, generates a new network device inventory record containing the switch 23 data, acquires the CDP neighbor device identities, such as the router 21 and the access point 24, by issuing an SNMP request with the IP address of the switch 23 and stores the newly discovered access point 24 identity in the queue. Finally, the discovery module 121 pops the access point 24 identity out of the queue, generates a new network device inventory record containing the access point 24 data, acquires the CDP neighbor device identity, such as the switch 23, by issuing an SNMP request with the IP address of the access point 24 and stores nothing in the queue. The resulting network device inventory records contain the data of the router 21, 22, switch 23 and access point 24.

The display module 122 provides a graphical user interface (GUI) to display the network device inventory records. The GUI provides a tree view to facilitate operator selection and to browse for the specific record.

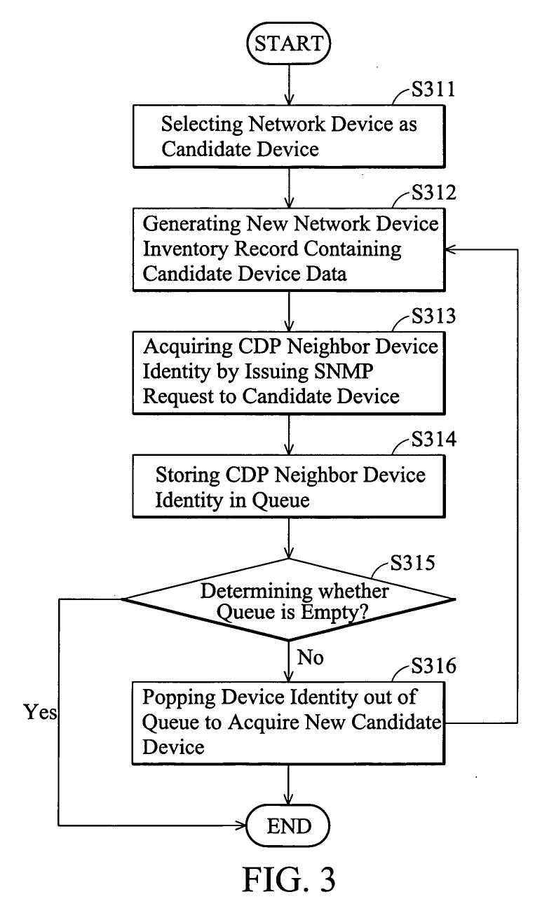

FIG. 3 is a flowchart showing the method of automated network device discovery according to the present invention. The method begins in step S311 by selecting a network device as a candidate device. In step S312, a new network device inventory record containing the candidate device data is generated. In step S313, CDP neighbor device identities are acquired by issuing an SNMP request with the IP address of the candidate device. The newly discovered device identities are stored in a queue as in step S314. Whether the queue is empty is determined as in step S321. If the queue is not empty, the process proceeds to step S331 to pop a device identity out of the queue on an FIFO basis to acquire a new candidate device and returns to step S312, otherwise, the process is complete.

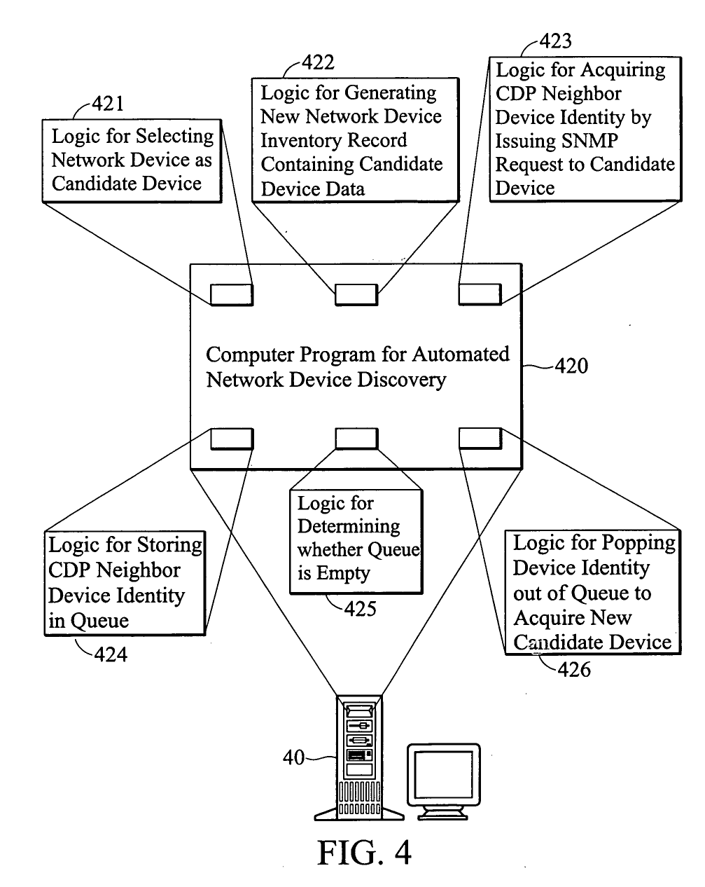

The invention additionally discloses a storage medium for storing a computer program providing the disclosed method of automated network device discovery, as shown in FIG. 4. The computer program product includes a storage medium 40 having computer readable program code embodied in the medium for use in a computer system, the computer readable program code comprising at least computer readable program code 421 selecting a network device as a candidate device, computer readable program code 422 generating a new network device inventory record containing candidate device data, computer readable program code 423 acquiring a CDP neighbor device identity by issuing an SNMP request to a network device, computer readable program code 424 putting a CDP neighbor device identity into a queue, computer readable program code 425 determining whether a queue is empty, and computer readable program code 426 popping a device identity out of a queue on FIFO basis to acquire new candidate device.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

The system and method of automated network device discovery recursively discovers CDP neighbor devices using the queue and the SNMP request, thereby reducing discovery time.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system of automated network device discovery, comprising:
a storage device; and
a discovery module, configured to issue a series of relayed single-destination simple network management protocol (SNMP) requests to a plurality of network devices to acquire a plurality of Cisco discovery protocol (CDP) neighbor device data, generate a plurality of network device inventory records corresponding to the CDP neighbor device data, and store the network device inventory records to the storage device.

2. The system of claim 1 wherein the discovery module further stores the CDP neighbor device data which is newly discovered to a queue and pops the CDP neighbor device data out of the queue for successive CDP neighbor device discovery.

3. The system of claim 2 wherein the CDP neighbor device identity is popped out of the queue on a first-in-first-out (FIFO) basis.

4. The system of claim 1 further comprising a display module, providing a graphical user interface (GUI) to facilitate selecting and browsing the network device inventory records.

5. The system of claim 1 wherein the network device stores a management interface base (MIB) file containing the CDP neighbor device data.

6. The system of claim 2 wherein the network device stores a management interface base (MIB) file containing the CDP neighbor device data.

7. The system of claim 3 wherein the network device stores a management interface base (MIB) file containing the CDP neighbor device data.

8. A method of automated network device discovery, the method comprising using a computer to perform the steps of:
issuing a series of relayed single-destination simple network management protocol (SNMP) requests to a plurality of network devices to acquire a plurality of Cisco discovery protocol (CDP) neighbor device data; and
generating a plurality of network device inventory records corresponding to the CDP neighbor data.

9. The method of claim 8 wherein the CDP neighbor device data is stored in a queue and popped out of the queue for successive CDP neighbor device discovery.

10. The method of claim 9 wherein the CDP neighbor device data is popped out of the queue on a first-in-first-out (FIFO) basis.

11. The method of claim 8 wherein the CDP neighbor device data is stored by a management interface base (MIB) file in the network device.

12. The method of claim 9 wherein the CDP neighbor device data is stored by a management interface base (MIB) file in the network device.

13. The method of claim 10 wherein the CDP neighbor device data is stored by a management interface base (MIB) file in the network device.

14. A machine-readable storage medium for storing a computer program which when executed performs a method of automated network device discovery, the method comprising the steps of:
issuing a series of relayed single-destination simple network management protocol (SNMP) requests to a plurality of network devices to acquire a plurality of Cisco discovery protocol (CDP) neighbor device data; and
generating a plurality of network device inventory records corresponding to the CDP neighbor data.

15. The machine-readable storage medium of claim 14 wherein the CDP neighbor device data is stored in a queue and popped out of the queue for successive CDP neighbor device discovery.

16. The machine-readable storage medium of claim 15 wherein the CDP neighbor device data is popped out of the queue on a first-in-first-out (FIFO) basis.

17. The machine-readable storage medium of claim 14 wherein the CDP neighbor device data is stored by a management interface base (MIB) file in the network device.

18. The machine-readable storage medium of claim 15, wherein the CDP neighbor device data is stored by a management interface base (MIB) file in the network device.

19. The machine-readable storage medium of claim 16 wherein the CDP neighbor device data is stored by a management interface base (MIB) file in the network device.
